(19) United States
(12) Patent Application Publication
(10) Pub. No.: US 2007/0047520 A1
(43) Pub. Date: Mar. 1, 2007

(54) Method for calling multimedia IP units about an impending emergency situation

(76) Inventors: Charles Calvin Byers, Wheaton, IL (US); Stuart Owen Goldman, Scottsdale, AZ (US); Richard E. Krock, Naperville, IL (US); Karl F. Rauscher, Emmaus, PA (US); James Philip Runyon, Wheaton, IL (US)

Correspondence Address: Lucent Technolgies Inc.;Docket Administrator, Room 3J-219, 101 Crawfords Corner Road, Holmdel, NJ, 07733-3030, US

(21) Appl. No.: 11/217,014

(22) Filed: Aug. 31, 2005

(51) Int. Cl. H04L 12/66

(52) U.S. Cl. 370/352

(57) ABSTRACT

The present invention provides a method for calling multimedia IP units about an impending emergency situation. A multimedia IP communication network or government authority forecasts the path of an impending emergency situation to create an impending impact area. The VoIP communication network determines the multimedia IP units that are located within the impending impact area. The multimedia IP communication network calls the multimedia IP units that are located within the impending impact area about the impending emergency situation, providing multi-media instructions to the users of the multimedia IP units.

### FIELD OF THE INVENTION

The present invention relates generally to communication systems, and more particularly to multimedia Internet Protocol (IP) communication systems.

### BACKGROUND OF THE INVENTION

Thousands of people are killed or injured every year by severe weather conditions or other disasters. Many of these tragedies could have been avoided if there were some way of alerting those people who are in the direct path of the most severe weather condition or disaster in time for them to take appropriate shelter or move out of the path of the disaster.

Many municipalities have early warning siren systems that provide general warnings, but unfortunately many people are unable to hear them, or don't realize the seriousness of a very general alarm until it is too late. Broadcast media are also a traditional means of distributing alerts of severe weather or other disasters, but people in the path of the weather aren't always tuned in to appropriate radio or television stations.

Therefore, a need exists for a method and apparatus that will provide highly accurate location identification with specific, real-time alerts for approaching emergency situations.

### BRIEF SUMMARY OF THE INVENTION

The present invention provides a method for alerting multimedia Internet Protocol (IP) communication units about an impending emergency situation. The communication units can be, for example, Voice over Internet Protocol (VoIP) communication units. The present invention provides a coordinating community alerting method for IP-based customer premises equipment (CPE) in a specific geographical area referred to as an impending impact area. The CPEs include network-connected IP-based units supporting IP-based multi-media units, such as VoIP telephony, IP video systems/IPTV, gaming systems, personal computers, and the like. These units may support other sub-tending wired or wireless IP devices. In an exemplary embodiment, CPEs in impending impact area are notified of an emergency incident, such as dangerous weather conditions or terrorist attacks. The CPEs in the impending impact area can be alerted utilizing one or more methods, such as calling, overriding sounds, streaming text, alerting messages, ring tones, caller ID messages, animation, graphics, or pop up messages.

In an exemplary embodiment, a multimedia IP communication network utilizes forecasting and emergency response networks to inform multimedia IP subscribers in the direct path of an emergency event to take appropriate precautions. The communication network uses the geographic location services that support 9-1-1 service for multimedia IP communication devices. The location information aids in routing emergency calls to the correct Public Safety Access Point (PSAP) serving the physical area from where the subscriber is calling. The location information is preferably used to notify subscribers of emergency situations within their immediate geographic area.

In accordance with an exemplary embodiment, central public safety authorities determine if a threat warrants an alert. The multimedia IP communication network determines which multimedia IP communication units are in the path of an impending emergency situation. The multimedia IP communication network calls or sends a message to the communication units that are in the path of the impending emergency situation. The call or message preferably instructs the subscribers to take appropriate precautionary action. The multimedia IP communication network uses geographic location information about the multimedia IP communication devices connected to the multimedia IP communication network to inform only the users that are in an area affected by the emergency situation.

The present invention thereby provides a method for informing users in the direct path of the emergency to take action much faster and more accurately than any mass media or civil defense system can. In an exemplary embodiment, the mass media and civil defense communication channels are augmented by providing an opportunity of direct calls to subscribers in the immediate area. Thus, citizens are alerted to the danger from multiple sources, such as the radio, TV, siren, or multimedia IP telephone call. By having all of these mechanisms running simultaneously the probability of citizens being altered to the danger increases, and the emergency instructions can be better tailored to the particular threat and to the needs of the user, for example the preferred language of the user.

In addition, users in the path of an impending emergency situation receive instructions specific to their particular situation, including the type of emergency situation, the direction that the emergency situation is moving, or other pertinent information, including multimedia information relating to the impending emergency situation. The instructions can be different depending upon the exact location of the emergency, and the users positional relation to it. For example, users located north of a toxic spill will be told to move north, while users south of it will be instructed to move south.

### BRIEF DESCRIPTION OF THE SEVERAL VIEWS OF THE DRAWINGS

FIG. 1 depicts a multimedia IP communication system and including a depiction of an impending emergency situation in accordance with an exemplary embodiment of the present invention.

FIG. 2 depicts a flowchart of a method for alerting VoIP communication units of an impending emergency situation in accordance with an exemplary embodiment of the present invention.

### DETAILED DESCRIPTION OF THE INVENTION

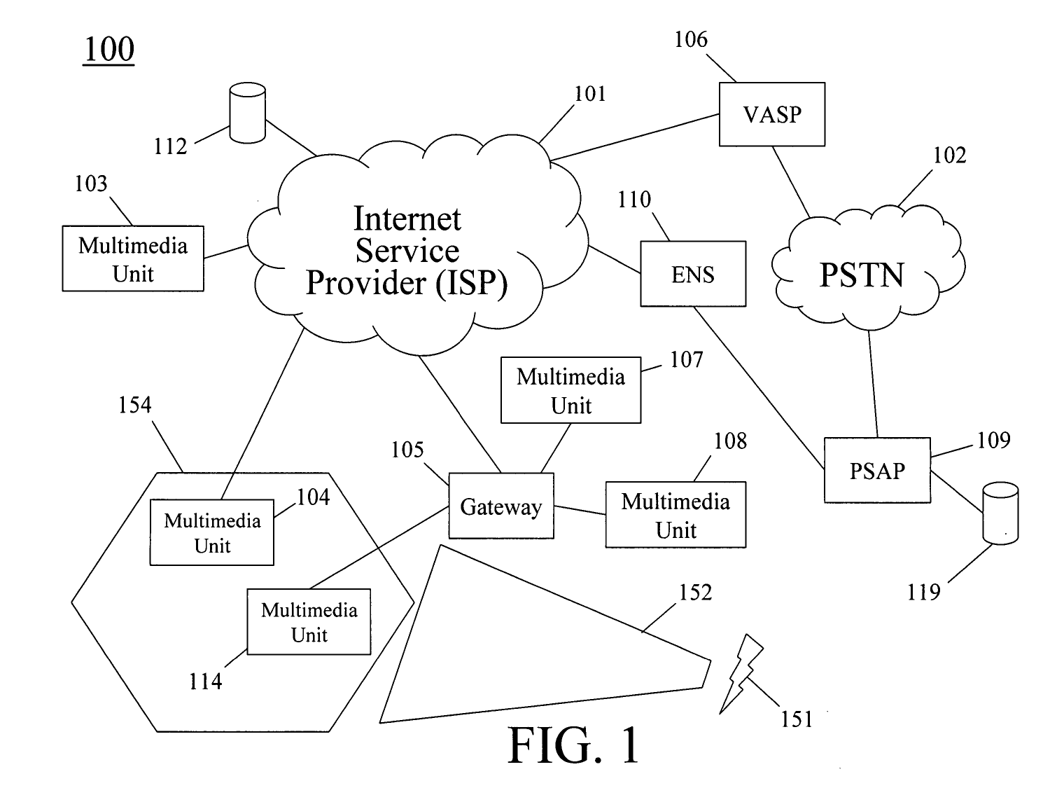

FIG. 1 depicts a multimedia IP communication system 100 and includes a depiction of an impending emergency situation 151 in accordance with an exemplary embodiment of the present invention. Multimedia IP communication system 100 comprises Internet Service Provider (ISP) 101, VoIP Application Service Provider (VASP) 106, Public Switched Telephone Network (PSTN) 102, Public Safety Answering Point (PSAP) 109, and Emergency Notification Server (ENS) 110. Multimedia IP communication units 103 and 104 communicate with ISP 101, which provides communication service. Gateway 105 communicates with ISP 101 and provides service to multimedia IP units 107, 108, and 114. Multimedia IP communication network 100 includes at least one ISP 101, and at least one VASP 106, but only one of each is depicted in FIG. 1 for clarity. Multimedia IP communication network 100 can also include video servers, game hosts, VPN boxes, and other multimedia systems that support IP multimedia communication.

ISP 101 provides access to multimedia IP communication system 100. ISP 101 may provide access via xDSL, cable modem, ISDN (Integrated Services Digital Network) or via private line hookups, such as T1 or fractional T1 lines. In addition, ISP 101 supports a database that can identify all IP-based customer premises equipment (CPE) by geographic location. ISP 101 preferably registers and maintains a database that includes the location of CPEs, in one embodiment using the cell towers registration of cell phones as a reference. The database also includes the location of all sub-tending devices, which can be several layers deep, and ultimately the location of each IP-device interface.

IP-based CPE enable the identification of its geographical location utilizing automatic location technologies such as global positioning system (GPS). In an alternate exemplary embodiment, the identification of geographical location comprises using wireline cable records or by utilizing a manual registration process that includes providing the geographical location of the user.

VASP 106 processes call and service requests initiated by one of the multimedia IP units and allocates the required transmission and signaling resources. VASP 106 is connected to PSTN 102 where the E911 service is provided. In an exemplary embodiment, PSTN 102 utilizes database 112 and PSAP 109 utilizes database 119 to provide the subscriber location information and the determination if the subscriber is in the affected area and should be called with an automated voice message. PSTN 102 is the worldwide voice telephone network.

ENS 110 is the central resource where the algorithms that determine which users are in impending impact area 154, which devices they have, which message types to send them, and the appropriate transmission paths to reach them operate. ENS 110 is preferably connected to the central emergency authorities, such as a government public safety agency, over which connection secure commands are issued.

Database 112 knows the alerting capabilities of the IP-based CPE and knows the best modes to alert each CPE. In an exemplary embodiment, different methods are used to communicate with each device at the customer premises. Database 119 includes the geographic location of all the devices within its serving area and can isolate the devices in impending impact area 154.

PSAP 109 is utilized to process emergency calls that are received by PSTN 102 or other entities, such as multimedia networks including E911 emails or instant messages. In accordance with an exemplary embodiment, PSAP 109 interfaces with the national weather system and other emergency response centers, such as state and national security centers.

PSAP 109 for 911 calls interfaces with the national weather system and other emergency response centers (i.e. state/national security centers). Further, ISPs will support a database that can identify all IP-based CPE by geographic location. IP-based CPE will enable the identification of its geographical location by one or more location identifying technologies, such as GPS or NOAA. PSAP 109 notifies, preferably via secure notification techniques such as strong authentication, the ISP of the impacted geographical area and provides the appropriate notification message for the various media and other pertinent information. The ISPs will then, for each IP-based CPE, send an appropriate emergency notification message using appropriate media stream type and language to each of these CPE units.

Multimedia IP communication system 100 may also interface with a wireless network and a plurality of multimedia IP networks, but only multimedia IP communication network 100 is depicted in FIG. 1 for clarity.

Multimedia IP communication network 100 can utilize any multimedia IP protocol, including but not limited to Session Initiation Protocol (SIP) protocol, and can utilize any suitable medium, including but not limited to cable, xDSL, Passive Optical Networks, wireless LAN/MAN technologies such as Wi-Fi (Wireless-Fidelity), WiMax, and IEEE 802.11. It should be understood that multimedia IP communication network 100 typically includes a plurality of VoIP VASPs, each of which communicates with a plurality of subscribers, ISPs, other VASPs, and PSTNs.

In accordance with an exemplary embodiment, multimedia IP units 103, 104, 107, 108, and 114 may be IP-based multi-media devices, such as VoIP phones, IP video devices, game systems, or personal computers, that are equipped to recognize emergency alerting messages and notify the user of the device. Multimedia IP units 103, 104, 107, 108, and 114 may support CPE for Voice (VoIP), IP multi-media (IP video) and IP data (PC). In an exemplary embodiment, previous settings of the multimedia IP unit such as calling number denial, auto muting, pop-up blocking, and parental controls, are overridden in order to alert the customer. In addition, multiple alerting methods may be used for a single device.

Impending emergency situation 151 is depicted as a lightning bolt. Impending emergency situation 151 can be any situation that could be dangerous to someone who comes in contact with it. Impending emergency situation 151 can be a weather condition, such as a thunderstorm, tornado, hurricane, dust storm, wildfire, or tsunami, or a geological condition, such as an earthquake, landslide, or volcano. Impending emergency situation 151 can alternately be a man-made disaster, such as a bomb, riot, hazardous material leak or spill, biological threat, or nuclear or radiological incident.

In addition, impending emergency situation 151 can be an “Amber Alert” notifying all multimedia IP devices within impending impact area 154 of a missing child. In this scenario, the notification can include photographs of the missing child, as well as other information that could be useful to the general public in finding the missing child, such as the height, weight, hair and eye color, and clothing that the child was last seen wearing.

Impending emergency situation can also be a closed highway. In this exemplary embodiment, any users that are determined to be on a highway and heading to a section of the road that is closed will be notified to the road closure. A user can be determined to be headed toward the closed highway via multiple determinations of locations, as well as extrapolations of the velocity and direction of the unit.

Impending emergency situation 151 can be moving or spreading. For example, if impending emergency situation 151 is a thunderstorm, hurricane, or tornado, it will most likely have a path of movement 152. Users who are in the path of impending emergency situation 151 would benefit by being alerted to the dangerous situation. This allows the users to move away from the path of impending emergency situation 151 or take appropriate cover from the dangerous situation.

The present invention utilizes a forecasted path 152 of impending emergency situation 151 to create an impending impact area 154. Impending impact area 154 depicts the geographic area into which impending emergency situation 151 is expected to move. In an exemplary embodiment, impending impact area 154 is a polygonal-shaped geographic region. The shape of impending impact area 154 is determined either by a manual process at PSAP 109 or through automatic means via algorithms in ENS 110.

Multimedia IP communication network 100 determines the multimedia IP units that are located within impending impact area 154. Database 112 shows the current location of the multimedia IP units and database 119 shows impending impact area 154. Databases 112 and 119 are consulted and a determination of which multimedia IP units should be notified is made. Multimedia IP communication network 100 alerts the multimedia IP units based upon proximity to and movement vector of the impending emergency situation.

The level of granularity of the alerting can be modified. For example, in a first exemplary embodiment that utilizes less precise location determinations, all multimedia IP units located within impending impact area 154 are alerted by multimedia IP communication network 100 of impending emergency situation 151.

Multimedia IP communication network 100 may prioritize the transmission of calls to multimedia IP units within impending impact area 154. Multimedia IP communication network 100 may send calls to multimedia IP units 104 and 114 based upon their proximity to impending emergency situation 151. In FIG. 1, multimedia IP communication network can send the first alert message to multimedia IP unit 114, and the second alert message to multimedia IP unit 104. In this manner, multimedia IP unit 114, which is disposed closest to impending emergency situation 151, will be given the first alert and will be able to take the first action to protect from impending emergency situation 151.

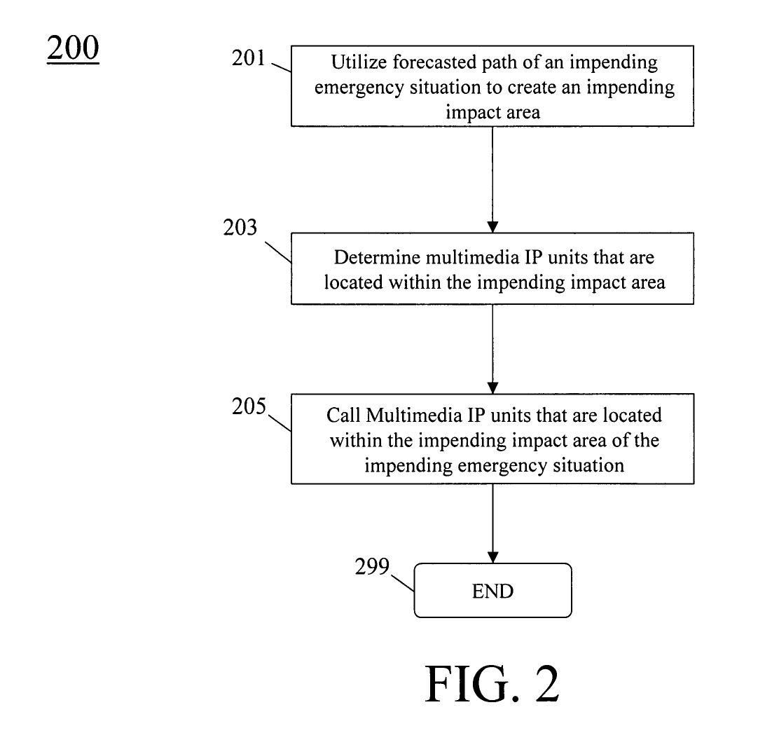

FIG. 2 depicts a flowchart 200 of a method for alerting multimedia IP communication units of an impending emergency situation in accordance with an exemplary embodiment of the present invention. In accordance with an exemplary embodiment, an automatic or manual registration process occurs prior to steps 201, 203, and 205 occurring. The registration includes the locations and capabilities of each multimedia IP communication unit.

The registration process preferably occurs before alerts are issued any multimedia IP communication network 100. In an exemplary embodiment, the registration is performed at the time a new account is created and when a new device is installed. The physical location of the unit is stored in a database, along with the capabilities and user preferences for the unit.

In accordance with an exemplary embodiment, a user can register a device with multimedia IP communication system 100. Registration preferably comprises a user connecting a device to multimedia IP communication system 100 and multimedia IP communication system 100 determining the location of the device. In an exemplary embodiment, the location determination is done semi-automatically, but can alternately be accomplished based upon cable records or upstream node locations. If multimedia IP communication system 100 cannot determine the location of the device using these methods, the user can be asked to enter the location of the device. Network consistency audits preferably check the location against cable and node location records, and if there is a mismatch, an investigation is requested.

Multimedia IP communication system 100 determines the multimedia capabilities of the device and a network database is updated to reflect the addition of the device.

A registration process is utilized for the network to populate the databases with information about the user's locations, language preferences, and the capabilities of their multimedia devices. This registration is preferably largely automated. However, under some circumstances, it is desirable for the user to enter some supplementary information the first time a particular device is used in a particular location.

During automatic registration, the network attempts to learn the physical location of a device, and its multimedia capabilities. In wired networks using point to point interconnection topology, such as ADSL, the local service provider has a database that knows the physical location of the end of subscriber's drop cable. This data is provided to the emergency notification system. In point to multipoint systems, such as cable TV or Passive Optical Networks, the service provider knows the electronic ID of the terminal device the user presumably has connected to the network, and this information can also be provided to the emergency notification system.

In more complicated situations, for example in a business or campus network, where an access facility terminates on a router and that router serves a plurality of users, perhaps spread over a large area, an automated protocol can map router ports to end user room numbers using the building's cable records. In a preferred embodiment, a manual registration process is used to validate a user's exact location when they first establish service, and after any router or cable repairs are performed that could disrupt the mapping of record.

In situations where wireless connections complete the last leg of a user's data path, such as Wi-Fi hotspots, some simple registration process is preferably carried out each time a user connects to the network. This process could be automated, and completed as part of the user's authentication as an allowed user of a hotspot. For example, if a user establishes a connection in a coffee shop, the authentication process could automatically transmit its geographic location to the emergency network. In situations where this is not feasible, the user would be asked to enter an address or business code if they wish to receive emergency alerts. Of course, if the Wi-Fi enabled user device also has its own geographic location capabilities, like GPS, the exact location is readily available from that.

In one exemplary embodiment, the network validates registrations to insure that the geographic coordinates are fairly close to the known location of the last non-mobile node, such as a router or Wi-Fi device. This prevents users who enter bogus locations or make typographical errors from contaminating the database. If the user insists that their entered location is correct, but the location of record for the serving node is unusually far away, an investigation is preferably conducted to insure that the network databases correctly reflect the locations of all network nodes and cable terminations.

Some of the characteristics of the user's multimedia capable devices are also important to the proper function of the emergency notification system. The network needs to know if each device has the capability to play sound, text, animation, etc, and what media formats it supports in order to send the appropriate notification messages. Often, the device can automatically provide this information when the network queries it during the registration process. For devices that have non-standard configurations, the users preferably enter the media stream types their devices are equipped to handle.

Even if the location registration process succeeded in a fully automatic way, the user may still want to perform a supplemental registration process. This is where the user could select preferred languages. Additional location info could be provided to assist emergency responders, such as hotel room 1313, PC in the kids bedroom in the Northeast corner of the second floor, campus building X, or room Y. Users could select the severity of events below which they receive no notification, for example, to ignore all thunderstorm warnings with wind speed below 30 mph. The user preferably selects a preferred alert type for first notification based upon the device they would typically be paying the most attention to, although it should be understood that the communication system will attempt to alert all active media capable devices in sequence. If the user also wants to receive notifications about events effecting some remote area, like a daycare center, office, relative's home, worksite, second home, etc., the registration process would allow that, and send an appropriate message to the notification server for that area.

Multimedia IP communication network 100 utilizes (201) a forecasted path 152 of impending emergency situation 151 to create impending impact area 154. In an exemplary embodiment, a central public safety authority determines the nature of the threat, the location and shape of the alert area, and the exact messages to be sent to all media types. Automatic systems can take pre-packaged alerts for various media types, such as sound files, images, maps, video clips, instant messages, animations, ring tones, and URLs of detailed instruction web pages, and quickly customize them with the specifics of the current emergency, and translated into various languages spoken by the users. In this step, the geographic data and the various media files are transmitted to the network.

In an exemplary embodiment, multimedia IP communication network 100 determines impending impact area 154 by analyzing weather-prediction data or WMD hazard footprint and generating a polygonal-shaped geographic region. The polygonal-shaped region represents the area into which impending emergency 151 is predicted to move. In an exemplary embodiment, a government authority uses the velocity of impending emergency situation 151, wind speed and direction, the spreading factor of impending emergency situation 151, and other factors to forecast path 152 of impending emergency situation 151. In an exemplary embodiment, this function is performed by ENS 110.

In an exemplary embodiment, multimedia IP communication network 100 works with the geo-location features that allow multimedia IP communication network 100 to determine the location of the multimedia IP units and a weather forecasting system. When severe weather events threaten, the weather service uses their forecasting infrastructure to determine a geographic region in the likely path of the storm. The geometry of this region, along with the specific emergency and instructions for users in the region, would be forwarded to multimedia IP communication network 100.

Multimedia IP communication network 100 determines (203) the multimedia IP units that are located within impending impact area 154. In an exemplary embodiment, this determination is performed by communication network servers that consult location databases showing the position of the multimedia IP units. In an exemplary embodiment, the step of determining the multimedia IP units that are located within the impending impact area comprises utilizing GPS satellites. In a further exemplary embodiment, the location of multimedia IP units is determined utilizing subscriber input directly or through VASP 106, which was preferably given during the registration process.

In a further exemplary embodiment, the step of determining the multimedia IP units that are located within impending impact area 154 comprises determining the location of ISP WiFi sites supporting the multimedia IP units that are located within impending impact area 154. In this embodiment, any WiFi site that will be touched by impending impact area 154 will transmit an alert to all multimedia IP units located within that location.

Emergency response centers, such as PSAP 109, preferably notify ISP 101 of impending impact area 154. This notification is preferably accomplished using a secure notification technique, such as strong authentication. The notification includes a notice of the impending emergency situation and other pertinent information. High security is essential to prevent false or malicious notifications to spoof official messages. Authentication certificates and extensive source and path tracing are important to maintain the integrity of the notification system.

In an exemplary embodiment, a first device fans out to multiple other wired devices, such as LANs and multi-dwelling units. In a further exemplary embodiment, the first device fans out to multiple other wireless devices, such as Wi-Fi/802.11a, b, g or WiMax/802.16. In addition, wireless sub-tending devices that are utilizing wireless service without authorization are also alerted to an impending emergency.

In accordance with an exemplary embodiment, a multimedia IP unit can opt out of receiving notification of incoming emergency events. In a further exemplary embodiment, multimedia IP units can receive emergency information about a second device or location that may not be the geographic area as the receiver's device. For example, a parent can subscribe to a service that alerts them to an impending emergency at the day care facility in which a child is located.

In accordance with an exemplary embodiment, ISP 101 knows the location of its point of interface to multimedia IP subscribers. In the case of dedicated connections, such as home subscribers, ISP 101 knows the home address of each subscriber. When an emergency situation occurs, ISP 101 consults an address database of their subscribers and sends a pop-up message or other appropriate alert to each subscriber currently attached to the network that is in the path of the emergency. This pop-up message preferably indicates the type of emergency and provides additional information, such as maps, directions, details about the emergency, or other pertinent information, to the subscriber's PC screen.

Nomadic users, such as portable computers, may not be located in their home location and therefore should be alerted to emergencies in the area where they are currently located. In the case of Wi-Fi or other wireless connections, ISP 101 may not know the identity of every subscriber connected to the interface point, but does know the physical location of the interface, and the approximate coverage area of that Wi-Fi port. When that area is in path 152 of emergency 151, ISP 101 sends a pop-up to every computer that is being served from the interface point. In the case of dial-up connections, most ISPs provide local dial-in numbers in multiple geographic areas. In this scenario, pop-up messages are sent to those computers that are connected to local numbers in the area of emergency 151. It is possible for someone to dial into the dial-in number of ISP 101 from a remote area. In this scenario, this user would receive a warning that would not apply. In addition, someone dialed into a distant ISP number would not receive the warning for the location he/she is currently in, unless a manual registration process notified the network of the user's location at the time of login.

In an exemplary embodiment, multimedia IP network 100 determines the capabilities of each device in impact area 154 and selects a message media type consistent with the device's capabilities. The media capabilities of the currently active device(s) at the user's location are analyzed, and appropriate media stream types are selected for each device. For example, a sound file with instructions, in addition to special attention ring tones and caller ID displays could be sent to a VoIP telephone. Video clips, graphics, maps, and animation could be sent to a TV or video device. Text, instant messages, sound files, animation, or pop-ups could be sent to computers. Networked game systems could receive sound and animation files. In many situations, a user may have several devices active concurrently. The network may send alert media streams to one or all of these devices, and prioritize the order that multiple devices are alerted based upon the network's capacity to notify the entire area, or which device the user is likely to be paying the most attention to.

If the user has expressed a language preference during a registration process, media streams could be selected in the preferred language. Automatic text translation and automatic speech synthesis algorithms can automate the production of all of the types of media streams in all required languages, so very little time would elapse between the time the instructions are entered and the entire notification file set translated into all languages and media types is ready. Alerts in multiple languages can be sent to a single subscriber location, in order to serve homes or businesses where more than one language is spoken. This increases the chances that the announcement regarding the impending emergency situation will be understood by the maximum number of people.

Multimedia IP communication network 100 calls (205) the multimedia IP units that are located within impending impact area 154. Multimedia IP communication network 100 calls each of the multimedia IP units 104 and 114 that are located within impending impact area 154. In an exemplary embodiment, the call includes an automated voice announcement that includes an indication of the type of emergency.

The call can also include multimedia information relating to emergency situation 151, such as maps, pictures, video, instructions, or other information that would be helpful to a user that is located in impending impact area 154. The information can include the location of shelters from the impending emergency situation, and could also include a map of the impending impact area. In an exemplary embodiment, the instructions can be unique for each user, and can be based upon the location of impending emergency situation 151 and the user's positional relation to it. For example, users located north of a toxic spill can be told to move north, while users located south of the toxic spill can be instructed to move south.

In an exemplary embodiment, the multimedia content of the alerting message is dependent on the multimedia IP CPE. For example, the multimedia content includes, but is not limited to, streaming text, sounds, sound files, pop-up windows, video imaging, animation, ring tones, caller ID displays, presence messages (such as Instant Messages), and geographic maps showing the impact area.

In an exemplary embodiment, pop-up windows are utilized to alert users of fixed computers or nomadic users employing computers to access the internet of impending emergencies such as severe weather or Weapons of Mass Destruction (WMD) incidents. The utilization of pop-up messages, along with forecasting and emergency response networks to identify subscribers in the direct path of an emergency event to take appropriate precautions, provides a way of alerting that segment of the population that may not have ready access to other forms of alert messages.

In accordance with an exemplary embodiment, pop up messages that are sent to multimedia IP units are tagged in such a way as to override pop up blockers. Pop up blockers are software that resides on a computer that is used to block any pop up windows that were not initiated by the user. These pop up ads can become annoying to a user and therefore are blocked. Since the information sent in a message in accordance with an exemplary embodiment of the present invention is vital to the safety of a user, pop up windows sent in accordance with an exemplary embodiment override the pop up blocker and are displayed on a user's computer in spite of the presence of the pop up blocker. Similar overrides are provided for spam filters, mute settings, parental controls, and calling number denial.

The multimedia IP emergency call preferably has a higher priority than a normal VoIP call and is preferably sent based upon the proximity of a multimedia IP unit to the impending emergency situation. In addition, the multimedia IP emergency call is preferably a secure call using appropriate security techniques, such as authentication, to prevent unauthorized use of spoofing of the system.

The present invention provides an additional means of alerting the public to local emergency conditions, the ability to broadcast that alert to a targeted geographical area, and the ability to provide additional, relevant information regarding the emergency to those likely in the affected geographical area. In an exemplary embodiment, a communication system utilizes pop-up messages and geographical information along with information about impending emergencies to alert multimedia IP users that may be in the path of the emergency.

In addition, the present invention allows IP-based units to register their multimedia IP unit with the ISP so that they can be notified when other points of interest (e.g., daycare centers, home, relatives, office) receive emergency notification. In this situation, the registered CPE will receive the same notification as the CPE in the impacted area.

While this invention has been described in terms of certain examples thereof, it is not intended that it be limited to the above description, but rather only to the extent set forth in the claims that follow.

1. A method for alerting multimedia Internet Protocol (IP) communication units about an impending emergency situation, the method comprising:
utilizing a forecasted path of an impending emergency situation to create an impending impact area;
determining a multimedia IP communication unit that is located within the impending impact area; and
calling the multimedia IP communication unit that is located within the impending impact area.

2. A method for alerting multimedia IP units about an impending emergency situation in accordance with claim 1, the method further comprising determining a nomadic multimedia IP communication unit that may enter the impending impact area.

3. A method for alerting multimedia IP units about an impending emergency situation in accordance with claim 1, wherein the step of calling the multimedia IP communication unit that is located within the impending impact area comprises sending an automated voice announcement to the multimedia IP communication unit that is located within the impending impact area, and wherein the automated voice announcement includes an indication of the type of emergency.

4. A method for alerting multimedia IP units about an impending emergency situation in accordance with claim 3, wherein the automated voice announcement includes the direction that the impending emergency situation is moving.

5. A method for alerting multimedia IP units about an impending emergency situation in accordance with claim 1, wherein the step of calling the multimedia IP communication unit that is located within the impending impact area comprises sending an alert message to the multimedia IP communication unit that is located within the impending impact area, and wherein the alert message includes multimedia information relating to the emergency.

6. A method for alerting multimedia IP units about an impending emergency situation in accordance with claim 1, wherein the step of calling the multimedia IP communication unit that is located within the impending impact area comprises sending a pop up window including information about the impending emergency information to the multimedia IP communication unit.

7. A method for alerting multimedia IP units about an impending emergency situation in accordance with claim 6, the method further comprising the step of overriding a pop up blocker that is being used by the multimedia IP communication unit.

8. A method for alerting multimedia IP units about an impending emergency situation in accordance with claim 1, wherein the step of determining the multimedia IP communication unit that is located within the impending impact area comprises utilizing a VoIP Application Service Provider (VASP) database.

9. A method for alerting multimedia IP units about an impending emergency situation in accordance with claim 1, wherein the step of calling the multimedia IP communication unit that is located within the impending impact area of the impending emergency situation comprises sending a call that has a higher priority than a normal call.

10. A method for alerting multimedia IP units about an impending emergency situation in accordance with claim 1, wherein the call includes an alert selected from the group consisting of overriding sounds, streaming text, alerting messages, ring tones, caller ID messages, animation, graphics, sound files, images, pictures, maps, video clips, instant messages, web pages, instructions, the location of shelters from the impending emergency situation, a map of the impending impact area, or pop up messages.

11. A method for alerting multimedia IP units about an impending emergency situation in accordance with claim 1, wherein the step of calling the multimedia IP communication unit that is located within the impending impact area of the impending emergency situation comprises overriding settings on the multimedia IP communication unit that are intended to block incoming calls.

12. A method for alerting multimedia IP units about an impending emergency situation in accordance with claim 1, wherein the step of calling the multimedia IP communication unit that is located within the impending impact area of the impending emergency situation comprises sending an Amber Alert to the multimedia IP communication unit.

13. A method for alerting multimedia IP units about an impending emergency situation in accordance with claim 12, wherein the Amber Alert includes a description of a missing child.

14. A method for alerting multimedia IP units about an impending emergency situation in accordance with claim 1, wherein the multimedia IP communication unit is connected to a communication network via an Internet Service Provider (ISP) WiFi site, and wherein the step of determining the multimedia IP communication unit that is located within the impending impact area comprises determining that the ISP WiFi site is located within the impending impact area.

15. A method for alerting multimedia IP units about an impending emergency situation in accordance with claim 1, wherein the step of calling the multimedia IP communication unit that is located within the impending impact area comprises utilizing a secure notification technique.

16. A method for alerting multimedia IP units about an impending emergency situation in accordance with claim 1, the method further comprising the step of calling a second multimedia IP communication unit when a first communication unit is located within the impending impact area.

17. A method for alerting multimedia IP units about an impending emergency situation in accordance with claim 1, wherein the step of calling the multimedia IP communication unit comprises sending a media stream that utilizes a language preselected by a user of the multimedia IP communication unit.

18. A method for alerting multimedia IP units about an impending emergency situation in accordance with claim 1, wherein the multimedia IP communication unit is connected to a router that serves a plurality of users, wherein the step of determining a multimedia IP communication unit that is located within the impending impact area comprises utilizing a room number of the multimedia IP communication unit, wherein the room number is determined by utilizing cable records of a building.

19. A method for alerting multimedia IP units about an impending emergency situation in accordance with claim 1, wherein the step of calling the multimedia IP communication unit that is located within the impending impact area comprises calling the multimedia IP communication unit before calling a second multimedia IP communication unit that is located a greater distance from the impending emergency situation than the multimedia IP communication unit.

20. A method for alerting multimedia IP units about an impending emergency situation in accordance with claim 1, wherein the step of determining a multimedia IP communication unit that is located within the impending impact area comprises determining a multimedia IP communication unit that is located within the impending impact area utilizing information obtained about the multimedia IP communication unit during an automatic registration process.

21. A method for alerting multimedia IP units about an impending emergency situation in accordance with claim 1, wherein the step of determining a multimedia IP communication unit that is located within the impending impact area comprises determining a multimedia IP communication unit that is located within the impending impact area utilizing information obtained about the multimedia IP communication unit during a manual registration process.

22. A method for alerting multimedia IP units about an impending emergency situation in accordance with claim 1, the method further comprising the step of checking the accuracy of location data for the multimedia IP communication unit.

23. A method for alerting multimedia IP units about an impending emergency situation in accordance with claim 1, the method further comprising the step of updating registration information when a status of a cable router that the multimedia IP communication unit is connected to changes.
